(19) United States
(12) Patent Application Publication
(10) Pub. No.: US 2025/0205652 A1
(43) Pub. Date: Jun. 26, 2025

(54) HOLLOW FIBER MEMBRANE, HOLLOW FIBER MEMBRANE STACK, AND FILTRATION MODULE

(71) Applicant: SUMITOMO ELECTRIC INDUSTRIES, LTD., Osaka (JP)

(72) Inventors: Hiroki MIYATA, Osaka (JP); Kazuya TOKUDA, Osaka (JP)

(73) Assignee: SUMITOMO ELECTRIC INDUSTRIES, LTD., Osaka (JP)

(21) Appl. No.: 18/852,257

(22) PCT Filed: Jan. 17, 2023
(86) PCT No.: PCT/JP2023/001167

§ 371 Date: Sep. 27, 2024

(30) Foreign Application Priority Data
Apr. 5, 2022 (JP) 2022-063137

(51) Int. Cl. B01D 69/08; B01D 63/04; B01D 69/02; B01D 71/36

(52) U.S. Cl. CPC B01D 69/08; B01D 63/04; B01D 69/02; B01D 71/36; B01D 2325/04

(57) ABSTRACT

A hollow fiber membrane according to an aspect of the present disclosure comprises polytetrafluoroethylene or modified polytetrafluoroethylene as a main component, wherein the hollow fiber membrane has: an average outer diameter of 2.10 mm or less and an average thickness of 0.60 mm or less; an isopropanol bubble point of 90 kPa or more; a degree of orientation in a longitudinal direction measured by wide-angle X-ray scattering from 72% to 85%; and an amount of heat of fusion at an endothermic peak in the vicinity of 328° C. from 10.0 J/g to 13.4 J/g.

### TECHNICAL FIELD

The present disclosure relates to a hollow fiber membrane, a hollow fiber membrane stack, and a filtration module. The present application claims the benefit of priority to Japanese Patent Application No. 2022-063137 filed on Apr. 5, 2022, the entire contents of which are incorporated herein by reference.

### BACKGROUND ART

Conventionally, as solid-liquid separation treatment apparatuses for use for treating waste water and for producing pharmaceuticals and the like, filtration apparatuses that comprise a filtration module having a plurality of hollow fiber membranes aligned in the vertical direction is used. A filtration apparatus of this type performs filtration treatment by preventing permeation of impurities from the treatment-target water at the surface of the hollow fiber membranes and allowing permeation of the water, except the impurities, to the interior of the hollow fiber membranes.

As a filtration module of this type, a filtration module that has hollow fiber membranes made of, for example, polytetrafluoroethylene (PTFE) is suggested, which can be optimized in terms of the IPA (isopropanol) bubble point, porosity, and the like of the hollow fiber membranes to increase the amount of water to be treated while ensuring high particle-trapping capability (see PTL 1).

### CITATION LIST

### Patent Literature

PTL 1: Japanese Patent Laying-Open No. 2010-42329

### SUMMARY OF INVENTION

A hollow fiber membrane according to an aspect of the present disclosure comprises polytetrafluoroethylene or modified polytetrafluoroethylene as a main component, wherein the hollow fiber membrane has: an average outer diameter of 2.10 mm or less and an average thickness of 0.60 mm or less; an isopropanol bubble point of 90 kPa or more; a degree of orientation in a longitudinal direction measured by wide-angle X-ray scattering from 72% to 85%; and an amount of heat of fusion at an endothermic peak in the vicinity of 328° C. from 10.0 J/g to 13.4 J/g.

### BRIEF DESCRIPTION OF DRAWINGS

FIG. 1 is a schematic cross-sectional view illustrating a hollow fiber membrane according to an embodiment of the present disclosure.

FIG. 2 is a schematic cross-sectional view illustrating a hollow fiber membrane stack according to an embodiment of the present disclosure.

FIG. 3 is a schematic cross-sectional view illustrating a filtration module according to an embodiment of the present disclosure.

### DETAILED DESCRIPTION

### Problem to be Solved by the Present Disclosure

In recent years, from the viewpoint of enhancing filtration performance of a filtration module, transmembrane pressure of hollow fiber membranes used as filtration filters during filtration operation is set high. However, when the transmembrane pressure of the hollow fiber membranes during filtration operation is high, the hollow fiber membranes can be crushed easily, potentially degrading filtration performance.

The present disclosure has been devised in view of these circumstances, and has an object to provide a hollow fiber membrane that tends not to be easily crushed due to a high transmembrane pressure during filtration operation.

### Advantageous Effect of the Present Disclosure

The hollow fiber membrane according to an aspect of the present disclosure tends not to be easily crushed due to a high transmembrane pressure during filtration operation.

### Description of Embodiments

First, aspects of the present disclosure will be described below.

A hollow fiber membrane according to an aspect of the present disclosure comprises polytetrafluoroethylene or modified polytetrafluoroethylene as a main component, wherein the hollow fiber membrane has: an average outer diameter of 2.10 mm or less and an average thickness of 0.60 mm or less; an isopropanol bubble point of 90 kPa or more; a degree of orientation in a longitudinal direction measured by wide-angle X-ray scattering from 72% to 85%; and an amount of heat of fusion at an endothermic peak in the vicinity of 328° C. from 10.0 J/g to 13.4 J/g.

With the hollow fiber membrane comprising polytetrafluoroethylene or modified polytetrafluoroethylene as a main component, chemical resistance and mechanical strength can be enhanced. With the hollow fiber membrane having an average outer diameter of 2.10 mm or less, an average thickness of 0.60 mm or less, and an isopropanol bubble point of 90 kPa or more, the size can be reduced while maintaining good filtration performance. In addition, with the hollow fiber membrane having a degree of orientation in a longitudinal direction measured by wide-angle X-ray scattering from 72% to 85%, strength of the hollow fiber membrane in the radial direction can be enhanced while maintaining good strength of the hollow fiber membrane in the longitudinal direction. Furthermore, with the hollow fiber membrane having an amount of heat of fusion at an endothermic peak in the vicinity of 328° C. from 10.0 J/g to 13.4 J/g, the degree of crystallinity of the hollow fiber membrane can be enhanced. Hence, the hollow fiber membrane has a high filtration performance, and, also, crushing of it due to a high transmembrane pressure during filtration operation is effectively reduced. Here, the “main component” refers to a component that has the highest content ratio in mass, where, for example, the content ratio is 50 mass % or more, preferably 70 mass % or more, more preferably 95 mass % or more.

The “average thickness” of the hollow fiber membrane can be determined by dividing ((average outer diameter)−(average inner diameter)) by 2. When a cross section of the hollow fiber membrane is circular, the “average outer diameter” refers to the average of any two outer diameters. When a cross section of the hollow fiber membrane is elliptical, two shorter diameters and two longer diameters are measured and the average is regarded as the average outer diameter. When a cross section of the hollow fiber membrane is different from a typical circle or ellipse, edge information of the outer diameter of a cross section is extracted to perform approximation to a circle, and the inner circumference thus obtained is divided by the circular constant to obtain the average outer diameter. The “average inner diameter” refers to the average of any two inner diameters. More specifically, the average outer diameter can be measured in the manner described below. First, the hollow fiber membrane is cut at a cross section vertical to the longitudinal direction, and the cross section is examined with an electron microscope in such a manner that the entire cross section is included within the field of view. Then, within the cross section, a set of two outer diameters are measured, each of which is measured between points that are approximately diagonal to each other (between points that are different in phase by about 90 degrees), and the resulting values are averaged to obtain the average outer diameter. The “average inner diameter” refers to the average of any two inner diameters. The average inner diameter can be measured by the manner described below. First, the hollow fiber membrane is cut at a cross section vertical to the longitudinal direction, and the cross section is examined with an electron microscope in such a manner that the entire cross section is included within the field of view. Then, within the cross section, a set of two inner diameters are measured, each of which is measured between points that are approximately diagonal to each other (between points that are different in phase by about 90 degrees), and the resulting values are averaged to obtain the average inner diameter. The “isopropanol bubble point” refers to a value measured in conformity with JIS-K 3832 (1990) using isopropanol, and indicates the minimum pressure required for pushing liquid out from a pore, an index corresponding to the average pore size.

The “degree of orientation” is measured in the longitudinal direction of the hollow fiber membrane, by wide-angle X-ray scattering. Measurement by wide-angle X-ray scattering is carried out in the following manner, for example. As the X-ray, BL16 which is available from a synchrotron radiation facility named SAGA-LS can be used. The wavelength can be set at 0.056 nm, for example (with a Si 111 double-crystal spectrometer). First, the hollow fiber membrane is irradiated through an incident light slit with a beam diameter of 0.3-mm wide and 0.3-mm long. The X-ray is scattered by the hollow fiber membrane and detected with a detector (PILATUS 100K manufactured by Dectris). The distance between the sample and the detector is 119.65 mm. The degree of orientation [%] of the hollow fiber membrane in the longitudinal direction was calculated from Debye Sherrer of a 100 diffraction peak (interplanar spacing, 0.4902 nm) obtained by measurement by wide-angle X-ray scattering. The orientation in the longitudinal direction is detected as an intensity in a direction deviated by 90° on the coordinates where the longitudinal direction is defined as 0°, so it is calculated by using the equation given below, in which x is the full width at half maximum [°] of the peak intensity obtained from the intensity profile acquired at an orientation angle from 0° to 180° (the width of the peak at half the height of the peak from which the background is excluded).

$$Degree of orientation [ \% ] = \{ ( 180 - x ) / 180 \} \times 100$$

The amount of heat of fusion of the hollow fiber membrane at an endothermic peak in the vicinity of 328° C. is measured with a differential scanning calorimeter, and it is the endothermic amount in the vicinity of 328° C. measured with a differential scanning calorimeter. “In the vicinity of 328° C.” means the range of 323° C. to 333° C. More specifically, the amount of heat of fusion of the hollow fiber membrane is the amount of heat of fusion at the time when heating is performed starting at 50° C. to reach 400° C. at a rate of 10° C./minute. The amount of the sample in the measurement is from 8 mg to 12 mg, and the sampling time is 1 second at a time.

A hollow fiber membrane stack according to another aspect of the present disclosure comprises the hollow fiber membrane, as well as one or a plurality of porous membranes having polytetrafluoroethylene or modified polytetrafluoroethylene as a main component and stacked on an outer circumferential surface of the hollow fiber membrane. As a result of the hollow fiber membrane stack comprising the hollow fiber membrane as well as one or a plurality of the porous membranes stacked on the outer circumferential surface of the hollow fiber membrane, the hollow fiber membrane functions as a protector for the porous membranes, and thereby mechanical strength and service life of the hollow fiber membrane stack can be enhanced while maintaining good filtration performance of the hollow fiber membrane stack.

A filtration module according to another aspect of the present disclosure comprises a plurality of the hollow fiber membrane stacks. With the filtration module comprising a plurality of the hollow fiber membrane stacks, the service life can be enhanced while maintaining good filtration performance.

### Detailed Description of Embodiments

In the following, a detailed description will be given of a hollow fiber membrane, a hollow fiber membrane stack, and a filtration module according to embodiments of the present disclosure, with reference to drawings.

### <Hollow Fiber Membrane>

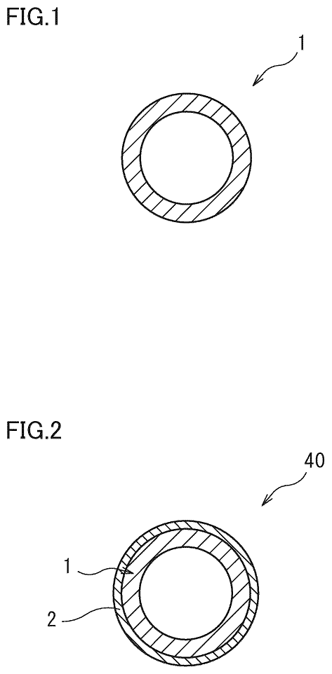

A hollow fiber membrane 1 in FIG. 1 comprises polytetrafluoroethylene or modified polytetrafluoroethylene as a main component. Because both polytetrafluoroethylene and modified polytetrafluoroethylene are fluororesins excellent in chemical resistance and solvent resistance, a wide variety of liquid and gas can be used to supply to the filtration module. Also, because both polytetrafluoroethylene and modified polytetrafluoroethylene are highly hydrophobic fluororesins, liquid leakage from hollow fiber membrane 1 can be reduced and gas permeation can be enhanced.

Modified polytetrafluoroethylene refers to a polytetrafluoroethylene obtained by copolymerization of tetrafluoroethylene with a small amount, preferably at most 1/50 (molar ratio) of the tetrafluoroethylene, of hexafluoropropylene (HFP), alkyl vinyl ether (AVE), chlorotrifluoroethylene (CTFE), and/or the like.

The lower limit to the average outer diameter of hollow fiber membrane 1 is not particularly limited, and it is preferably 1.8 mm, more preferably 1.9 mm. The upper limit to the average outer diameter of hollow fiber membrane 1 is 2.1 mm, more preferably 1.95 mm. When the average outer diameter is below the above-mentioned lower limit, pressure loss can be great. On the other hand, when the average outer diameter exceeds the above-mentioned upper limit, the membrane area that can fit inside a casing can become smaller and/or the distance between the membranes can become smaller, potentially causing a degradation of permeation properties of each membrane.

The lower limit to the average inner diameter of hollow fiber membrane 1 is not particularly limited, and it is preferably 0.9 mm, more preferably 0.95 mm. The upper limit to the average inner diameter of the hollow fiber membrane is preferably 1.15 mm, more preferably 1.10 mm. When the average inner diameter is below the above-mentioned lower limit, pressure loss can be great. On the other hand, when the average inner diameter exceeds the above-mentioned upper limit, compressive strength can become smaller, and thereby a rupture can occur due to internal pressure and/or a buckling can occur due to external pressure.

The lower limit to the average thickness of hollow fiber membrane 1 is preferably 0.38 mm, more preferably 0.4 mm. The upper limit to the average thickness of hollow fiber membrane 1 is 0.60 mm, preferably 0.45 mm. When the average thickness is below the above-mentioned lower limit, compressive strength can become smaller, and thereby a rupture can occur due to internal pressure and/or a buckling can occur due to external pressure. On the other hand, when the average thickness exceeds the above-mentioned upper limit, filtration performance can become insufficient.

The lower limit to the isopropanol bubble point of hollow fiber membrane 1 is 90 kPa, preferably 95 kPa. The upper limit to the isopropanol bubble point of hollow fiber membrane 1 is preferably 125 kPa, more preferably 120 kPa. When the isopropanol bubble point of hollow fiber membrane 1 is below the above-mentioned lower limit, there is a possibility that impurities cannot be separated sufficiently. When the isopropanol bubble point of hollow fiber membrane 1 exceeds the above-mentioned upper limit, the amount of water that can permeate across hollow fiber membrane 1 can become insufficient, potentially causing a degradation of filtering efficiency of hollow fiber membrane 1.

The lower limit to the degree of orientation of hollow fiber membrane 1 in the longitudinal direction measured by wide-angle X-ray scattering is 72%, preferably 73%. The upper limit to the degree of orientation of hollow fiber membrane 1 in the longitudinal direction is 85%, preferably 75%. When the degree of orientation in the longitudinal direction is below 72%, strength of hollow fiber membrane 1 in the longitudinal direction can become low, potentially resulting in insufficient tensile strength. On the other hand, when the average thickness exceeds the above-mentioned upper limit, strength in the radial direction can be insufficient, potentially making it impossible to reduce crushing that can occur due to a high transmembrane pressure during filtration operation. With the degree of orientation of hollow fiber membrane 1 in the longitudinal direction measured by wide-angle X-ray scattering falling within the above-mentioned range, strength of the hollow fiber membrane in the radial direction can be enhanced while maintaining good strength of hollow fiber membrane 1 in the longitudinal direction.

The upper limit to the amount of heat of fusion of hollow fiber membrane 1 at an endothermic peak in the vicinity of 328° C. is 13.4 J/g, more preferably 13.3 J/g. The lower limit to the amount of heat of fusion of hollow fiber membrane 1 at an endothermic peak in the vicinity of 328° C. is 10.0 J/g, more preferably 11.0 J/g. When the amount of heat of fusion of hollow fiber membrane 1 exceeds the above-mentioned upper limit, the pore size can become large. On the other hand, when the amount of heat of fusion of hollow fiber membrane 1 is below the above-mentioned lower limit, the porosity can become low. With the amount of heat of fusion of hollow fiber membrane 1 falling within the above-mentioned range, hollow fiber membrane 1 to be obtained can have a high degree of crystallinity and its pore size can fall within a good range. Hence, even when hollow fiber membrane 1 has an average outer diameter of 2.0 mm or less and an average thickness of 0.45 mm or less, crushing due to a high transmembrane pressure during filtration operation is effectively reduced.

As long as a desired effect of the present disclosure is not impaired, hollow fiber membrane 1 may contain other fluororesins, in addition to polytetrafluoroethylene and modified polytetrafluoroethylene, as well as additives. Examples of the additives include an inorganic filler for wear resistance improvement and pore formation facilitation, metal powder, metal oxide powder, metal sulfide powder, and the like.

### [Method of Producing Hollow Fiber Membrane]

Next, a description will be given of an example of a method of producing the hollow fiber membrane. The method of producing the hollow fiber membrane comprises, for example, a step to shape particles of polytetrafluoroethylene or modified polytetrafluoroethylene into a round tubular primary shaped body (a primary-shaped-body shaping step), a step to perform extrusion shaping of the primary shaped body into a round tubular body (an extrusion shaping step), a step to stretch the round tubular body in the longitudinal direction while heating (a stretching step), and heat treatment to heat the stretched round tubular body to a temperature equal to or above the melting point of PTFE (a heat treatment step).

### (Primary-Shaped-Body Shaping Step)

In the primary-shaped-body shaping step, a raw material that contains powder of polytetrafluoroethylene or modified polytetrafluoroethylene blended with a liquid lubricant is subjected to compression shaping. The powder of polytetrafluoroethylene or modified polytetrafluoroethylene in the raw material consists of fine particles of polytetrafluoroethylene or modified polytetrafluoroethylene, for example. Specific examples include fine powder of polytetrafluoroethylene or modified polytetrafluoroethylene produced by emulsion polymerization, and molding powder of polytetrafluoroethylene or modified polytetrafluoroethylene produced by suspension polymerization.

As the liquid lubricant to be blended with the powder of polytetrafluoroethylene or modified polytetrafluoroethylene (the raw material powder), various lubricants conventionally used in paste extrusion can be used. Examples thereof include petroleum-based solvents such as naphtha and white oil, hydrocarbon oils such as undecane, aromatic hydrocarbons such as toluol and xylol, alcohols, ketones, esters, silicone oils, fluorochlorocarbon oils, solutions obtained by dissolving a polymer such as polyisobutylene and/or polyisoprene in these solvents, mixtures of two or more of these, and aqueous solutions containing a surfactant. Preferably, the liquid lubricant is composed of a single component, for ease of uniform mixing.

The lower limit to the amount of the liquid lubricant to be used is preferably 20 parts by mass, more preferably 22 parts by mass, relative to 100 parts by mass of the raw material powder. The upper limit to the amount of the liquid lubricant to be used is preferably 28 parts by mass, more preferably 25 parts by mass, relative to 100 parts by mass of the raw material powder. When the amount of the liquid lubricant to be used is below the above-mentioned lower limit, lubrication can be insufficient, potentially making it difficult to perform extrusion shaping in the subsequent round-tubular-body shaping step. On the other hand, when the amount of the liquid lubricant to be used exceeds the above-mentioned upper limit, the round tubular body can become easily torn in the stretching step later.

The length of the primary shaped body to be formed, in the longitudinal direction, may be selected to be equal to or smaller than the stroke of a cylinder of an extrusion shaping machine to be used in the subsequent round-tubular-body shaping step.

### (Extrusion Shaping Step)

In the extrusion shaping step, an extrusion shaping machine equipped with a die having a circular opening and a core pin positioned at the center of the opening of the die is used to shape the primary shaped body into a tube form. The extrusion shaping is carried out at a temperature below the melting point of polytetrafluoroethylene or modified polytetrafluoroethylene, and generally, it is carried out at normal temperature.

Preferably, in the extrusion shaping step, the round tubular body extruded from the die is heated to volatilize the liquid lubricant. With the liquid lubricant removed in this way, stretching of the round tubular body in the subsequent stretching step can be carried out in a stable manner.

In addition, in the extrusion shaping step, the round tubular body extruded from the die may be taken up at a speed faster than the speed of extrusion from the die, to perform primary stretching of the round tubular body. The stretch factor of the primary stretching can be set at 150% to 170%, for example.

In the extrusion shaping, the greater the reduction rate (the ratio of the cross-sectional area of the primary shaped body and the area between the die and the core pin) is, the more oriented the molecular chain of polytetrafluoroethylene or modified polytetrafluoroethylene becomes in the longitudinal direction of the round tubular body, increasing the strength of the round tubular body in the longitudinal direction but also decreasing the strength in the radial direction.

The lower limit to the reduction rate in the extrusion shaping step is preferably 800, more preferably 850. The upper limit to the reduction rate in the extrusion shaping is preferably 1200, more preferably 1150. When the reduction rate in the extrusion shaping is below the above-mentioned lower limit, efficiency of forming the round tubular body can become insufficient, and/or strength of the round tubular body in the longitudinal direction can become insufficient and thereby the round tubular body can become easily torn in the subsequent stretching step. On the other hand, when the reduction rate in the extrusion shaping exceeds the above-mentioned upper limit, strength of the round tubular body in the radial direction can become low and thereby the strength of the resulting hollow fiber membrane can become insufficient.

### (Stretching Step)

In the stretching step, the round tubular body is stretched in the longitudinal direction while heating, to reduce the diameter to a desired diameter. Hence, the stretch factor in the stretching step is set so that the total stretch factor, which takes into consideration the primary stretching in the extrusion shaping step, becomes a proper value. Also in this stretching step, the molecular chain of polytetrafluoroethylene or modified polytetrafluoroethylene becomes further orientated in the longitudinal direction of the round tubular body.

The lower limit to the heating temperature at the time of stretching is preferably 200° C., more preferably 220° C. The upper limit to the heating temperature at the time of stretching is preferably 300° C., more preferably 280° C. When the heating temperature at the time of stretching is below the above-mentioned lower limit, there is a possibility that the round tubular body cannot be stretched enough fast. On the other hand, when the heating temperature at the time of stretching exceeds the above-mentioned upper limit, due to variations in temperature, the temperature can exceeds the melting point of polytetrafluoroethylene or modified polytetrafluoroethylene to cause tearing of the round tubular body.

### (Heat Treatment Step)

In the heat treatment step, the round tubular body thus stretched is heated to a temperature that is equal to or above the melting point of polytetrafluoroethylene or modified polytetrafluoroethylene. This makes it possible to reduce the degree of orientation of the hollow fiber membrane in the longitudinal direction to adjust it to fit within a good range. More specifically, by the heat treatment step, the degree of orientation of the hollow fiber membrane in the longitudinal direction is adjusted to the range of 72% to 85%. The heating temperature in the heat treatment step is preferably from 330° C. to 370° C., and the heating time is preferably from 15 minutes to 60 minutes.

By using the hollow fiber membrane, it is possible to reduce crushing that can occur due to a high transmembrane pressure during filtration operation.

### <Hollow Fiber Membrane Stack>

The hollow fiber membrane stack comprises the hollow fiber membrane, as well as one or a plurality of porous membranes having polytetrafluoroethylene or modified polytetrafluoroethylene as a main component and stacked on an outer circumferential surface of the hollow fiber membrane. Comprising polytetrafluoroethylene or modified polytetrafluoroethylene as a main component, the porous membrane(s) can have enhanced heat resistance, chemical stability, and the like.

FIG. 2 is a schematic cross-sectional view illustrating a hollow fiber membrane stack according to an embodiment of the present disclosure. A hollow fiber membrane stack 40 illustrated in FIG. 2 comprises hollow fiber membrane 1, as well as one or a plurality of porous membranes 2 stacked on an outer circumferential surface of hollow fiber membrane 1. In hollow fiber membrane stack 40, hollow fiber membrane 1 functions as a support film and porous membrane(s) 2 functions as a filtering layer. As a result of hollow fiber membrane stack 40 comprising hollow fiber membrane 1 as well as one or a plurality of porous membranes 2 stacked on the outer circumferential surface of hollow fiber membrane 1, hollow fiber membrane 1 functions as a protector for porous membrane(s) 2. Thereby, mechanical strength and service life of hollow fiber membrane stack 40 can be enhanced while maintaining good filtration performance of hollow fiber membrane stack 40.

The upper limit to the average thickness of one layer of porous membrane 2 is preferably 20 μm, more preferably 18 μm. The lower limit to the average thickness of porous membrane 2 is preferably 8 μm, more preferably 10 μm. When the average thickness of porous membrane 2 exceeds the above-mentioned upper limit, pressure loss of hollow fiber membrane stack 40 can be great. On the other hand, when the average thickness of porous membrane 2 is below the above-mentioned lower limit, strength of hollow fiber membrane stack 40 can be insufficient.

The hollow fiber membrane stack may have a three-layer structure, and, for example, it is possible that two porous membrane layers may be stacked on the hollow fiber membrane, which is a support film serving as the innermost layer. Alternatively, the hollow fiber membrane stack may have a structure of four or more layers.

### [Method of Producing Hollow Fiber Membrane Stack]

A description will be given of an embodiment of a method of producing the hollow fiber membrane stack in the case where the hollow fiber membrane stack comprises the hollow fiber membrane as a support film as well as the porous membrane(s). The method of producing the hollow fiber membrane stack comprises a step to wrap the outer circumferential surface of the hollow fiber membrane with a porous belt-shaped body in a spirally fashion in such a manner that both ends of the porous belt-shaped body overlap with one another (a wrapping step), and a step to bond the hollow fiber membrane and the belt-shaped body together by heating (a bonding step).

### (Wrapping Step)

The porous belt-shaped body containing PTFE as a main component is wrapped spirally on the outer circumferential surface of the hollow fiber membrane, and, thereby, a porous membrane is stacked thereon.

Preferably, for use as the belt-shaped body to be wrapped around the hollow fiber membrane, a PTFE sheet is stretched so that pores are formed in it.

The lower limit to the average width of the belt-shaped body to be wrapped around the hollow fiber membrane is 6.0 mm, preferably 6.5 mm. The upper limit to the average width of the belt-shaped body to be wrapped around the hollow fiber membrane is 12.0 mm, preferably 11.5 mm. When the average width of the belt-shaped body to be wrapped around the hollow fiber membrane is below the above-mentioned lower limit, the area of the overlapping region of the belt-shaped body can be great, and thereby the filtration performance of the resulting hollow fiber membrane stack can be improperly low. On the other hand, when the average width of the belt-shaped body to be wrapped around the hollow fiber membrane exceeds the above-mentioned upper limit, the angle formed by the belt-shaped body against the radial direction of the hollow fiber membrane during wrapping can be great, potentially making it difficult to wrap the belt-shaped body.

### (Bonding Step)

In the bonding step, the hollow fiber membrane, the outer circumferential surface of which is wrapped with the belt-shaped body for forming a porous membrane, is heated to a temperature equal to or above the melting point of PTFE. As a result, the overlapping edges of the belt-shaped body are bonded together to form a continuous porous membrane, and, at the same time, the porous membrane and the hollow fiber membrane are made into a one component.

The heating temperature in the bonding step can be from 350° C. to 400° C., for example, and the heating time can be from 1 minute to 10 minutes, for example. Because the hollow fiber membrane stack has the hollow fiber membrane functioning as a protector for the porous membrane(s), mechanical strength and service life of the hollow fiber membrane stack can be enhanced while maintaining good filtration performance of the hollow fiber membrane stack. Therefore, the hollow fiber membrane stack is excellent in filtration performance and mechanical strength, and suitable as a filtration filter.

### <Filtration Module>

The filtration module comprises a plurality of the hollow fiber membrane stacks. The filtration module is used in a membrane separation apparatus that operates to remove impurities from treatment-target water and discharge filtered water. The filtration module is used in micro-filtration apparatuses, ultrafiltration apparatuses, reverse osmosis apparatuses, and the like, for example.

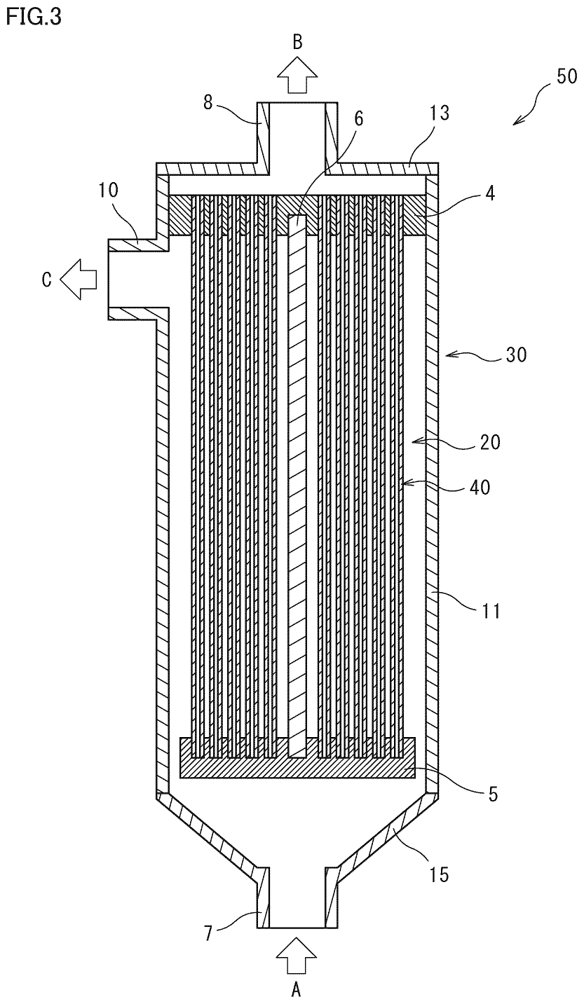

FIG. 3 illustrates a filtration module 50 according to an embodiment of the present disclosure. Filtration module 50 is a filtration module of external pressure type, and comprises a membrane member 20 having a plurality of hollow fiber membrane stacks 40 aligned in one direction, as well as a tubular casing 30 that accommodates membrane member 20. Moreover, filtration module 50 also comprises a first holding member 4 that secures one end of the plurality of hollow fiber membrane stacks 40 inside the casing 30, a second holding member 5 that secures the other end of the plurality of hollow fiber membrane stacks 40 inside the casing 30, and a supporting member 6 that maintains the distance between first holding member 4 and second holding member 5. For example, supporting member 6 is composed of a supporting pipe made of metal spanned between first holding member 4 and second holding member 5.

Each of the plurality of hollow fiber membrane stacks 40, first holding member 4, and second holding member 5 is configured as a cartridge detachable from casing 30. In other words, first holding member 4 and second holding member 5 are not bonded to the inner circumferential surface of casing 30. In filtration module 50, even when each of the plurality of hollow fiber membrane stacks 40, first holding member 4, and second holding member 5 is configured as a cartridge, the distance between first holding member 4 and second holding member 5 are maintained by supporting member 6 and, as a result, entanglement and the like of hollow fiber membrane stacks 40 can be reduced properly.

As casing 30, a casing in conformity with existing specifications can be used. Casing 30 has a barrel member 11 having its inner diameter substantially uniform in the axial direction, a cap member 13 connected to one end of barrel member 11, and a bottom member 15 connected to the other end of barrel member 11. Barrel member 11 is round tubular, for example. In the present embodiment, the central axis of barrel member 11 is positioned vertically. To the inner circumferential surface of barrel member 11, first holding member 4 is detachably connected. In other words, first holding member 4 is detachably connected to a flat, even surface of casing 30. At an upper portion of the peripheral wall of barrel member 11, a waste-water outlet 10 is provided. Cap member 13 is detachably connected to barrel member 11. Cap member 13 has a filtered-water outlet 8 from which a filtered water B permeated across the plurality of hollow fiber membrane stacks 40 can be discharged. Bottom member 15 has a funnel-like shape tapering downwardly, and at its end, has a treatment-target-water inlet 7 from which a treatment-target water A can be introduced into casing 30. On a side surface of casing 30, waste-water outlet 10 is provided from which a waste water C is discharged. The position and orientation of treatment-target-water inlet 7, filtered-water outlet 8, and waste-water outlet 10 are not particularly limited, and can be designed as appropriate for how the filtration module 50 is disposed. The expression “having its inner diameter substantially uniform” means that the ratio of the largest value of the inner diameter to the smallest value in the entire axial direction is from 1.00 to 1.10, for example, preferably from 1.00 to 1.05.

Filtration module 50 performs filtration treatment in the following manner: treatment-target water A is introduced from treatment-target-water inlet 7 into casing 30; and while permeation of impurities is being inhibited at the outer circumferential surface of the plurality of hollow fiber membrane stacks 40, filtered water B that permeated across the plurality of hollow fiber membrane stacks 40 is discharged from the filtered-water outlet 8. Moreover, filtration module 50 is configured to discharge waste water C, which contains impurities that did not permeate across the plurality of hollow fiber membrane stacks 40, out from the waste-water outlet 10.

By using the filtration module, which comprises the plurality of hollow fiber membrane stacks, it is possible to enhance service life while maintaining filtration performance.

### OTHER EMBODIMENTS

It should be construed that the embodiments disclosed herein are given by way of illustration in all respects, not by way of limitation. It is intended that the scope of the present disclosure is defined by claims, not limited by the configurations of the embodiments described above, and encompasses all modifications and variations equivalent in meaning and scope to the claims.

### Examples

In the following, a more detailed description will be given of the present

invention with reference to examples. However, the present invention is not limited to these examples.

### <Hollow Fiber Membrane: Test No. 1 to No. 6>

PTFE fine powder (“F104” manufactured by Daikin), which was a raw material powder, was used as a raw material. To the raw material powder, a liquid lubricant (“FP-25” manufactured by Idemitsu) was mixed in an amount of 25 parts by mass relative to 100 parts by mass of the raw material powder, and the resultant was compacted with a preliminary shaping machine into a round tubular shape. Then, an extruder was used to shape it into a round tubular body. The temperature of the cylinder and the die was set at 50° C.

Then, the resulting round tubular body was stretched at 200° C. The average outer diameter and the average thickness of the round tubular body thus stretched are given in Table 1. Each of the average outer diameter and the average thickness was the average of values measured at freely selected points.

Then, the stretched round tubular body of Test No. 2 to No. 6 was subjected to heat treatment under the heating conditions specified in Table 1. The stretched round tubular body of Test No. 1 was not subjected to the heat treatment step.

### [Measurement of Value of Physical Properties]

### (Measurement of Amount of Heat of Fusion)

A heat-flux differential scanning calorimeter (“DSC60-A” manufactured by Shimadzu Corporation) was used to measure the amount of heat of fusion [J/g] of 10 mg of a hollow fiber membrane sample at an endothermic peak in the vicinity of 328° C., under the conditions specified below.

### (Degree of Orientation)

For the hollow fiber membrane of Test No. 1 to No. 6, the degree of orientation [%] in the longitudinal direction was measured by the above-mentioned measurement method.

### (Isopropanol (IPA) Bubble Point)

The IPA bubble point [kPa] was measured in accordance with JIS-K 3832 (1990), with the use of isopropanol as a test liquid.

### (Isopropanol (IPA) Flow Rate)

As for measurement of the IPA flow rate [mL/minute], the flow rate of isopropanol permeating across the hollow fiber membrane was measured, with the differential pressure set at 0.1 MPa and the length of the membrane set at 10 cm.

### [Evaluation of Hollow Fiber Membrane]

(Strength against External Pressure)

Water pressure was applied to the hollow fiber membrane of Test No. 1 to No. 6 from the outside of the hollow fiber membrane, and the pressure [kPa] at the time when crushing of the membrane was visually observed was measured.

### (Tensile Strength)

Tensile strength (maximum tensile stress) [MPa] of the hollow fiber membrane of Test No. 1 to No. 6 was measured in accordance with JIS-K 7161 (2014), with the distance between reference lines set at 100 mm and the test rate set at 100 mm/min.

Results of measurement of the degree of orientation, isopropanol flow rate, isopropanol bubble point, amount of heat of fusion, strength against external pressure, and tensile strength of the hollow fiber membrane of Test No. 1 to No. 6 are given in Table 1.

TABLE 1

| | Conditions in | Values of physical properties of hollow fiber membrane | | | | | | Evaluation | |
|---|---|---|---|---|---|---|---|---|---|
| Hollow | heat treatment | Average | | | | | Amount of heat of | Strength | |
| fiber | step | outer | Average | Degree of | IPA flow | IPA bubble | fusion [J/g] at | against | Tensile |
| membrane | [° C., | diameter | thickness | orientation | rate | point | endothermic peak | external | strength |
| Test No. | minutes] | [mm] | [mm] | [%] | [mL/minute] | [kPa] | at 328° C. | pressure [kPa] | [MPa] |
| No. 2 | 330° C. | 1.90 | 0.40 | 78 | 98 | 104 | 11.24 | 200 | 25.7 |
| | 15 minutes | | | | | | | | |
| No. 3 | 350° C. | 1.90 | 0.43 | 75 | 104 | 110 | 12.98 | 220 | 25.4 |
| | 15 minutes | | | | | | | | |
| No. 4 | 350° C. | 1.87 | 0.39 | 76 | 84 | 98 | 12.78 | 220 | 24.2 |
| | 60 minutes | | | | | | | | |
| No. 5 | 370° C. | 1.86 | 0.45 | 73 | 88 | 100 | 13.22 | 240 | 21.2 |
| | 60 minutes | | | | | | | | |
| No. 1 | None | 1.99 | 0.51 | 87 | 112 | 115 | 8.85 | 180 | 23.5 |
| No. 6 | 380° C. | — | — | 70 | — | — | 13.68 | Broken | Broken |
| | 60 minutes | | | | | | | | |

As seen in Table 1, the hollow fiber membrane of Test No. 2 to Test No. 5 having an average outer diameter of 2.10 mm or less, an average thickness of 0.60 mm or less, an isopropanol bubble point of 90 kPa or more, a degree of orientation in the longitudinal direction from 72% to 85%, and an amount of heat of fusion at an endothermic peak in the vicinity of 328° C. from 10.0 J/g to 13.4 J/g had high strength against external pressure and high tensile strength. This indicates that the hollow fiber membrane of No. 2 to No. 5 is good in both the strength in the longitudinal direction and the strength in the radial direction. On the other hand, the hollow fiber membrane of Test No. 1 having a degree of orientation in the longitudinal direction exceeding 85% had relatively less strength against external pressure, indicating that the effect to reduce crushing that can occur due to a high transmembrane pressure during filtration operation is relatively low. The hollow fiber membrane of Test No. 6 having a degree of orientation in the longitudinal direction below 72% and an amount of heat of fusion at an endothermic peak in the vicinity of 328° C. exceeding 13.4 J/g broke in the strength-against-external-pressure test and the tensile strength test.

As described above, it was proven that the above-mentioned hollow fiber membrane is excellent in effectively reducing crushing that can occur due to a high transmembrane pressure during filtration operation. Hence, the above-mentioned hollow fiber membrane is suitable for filtration apparatuses for use in waste water treatment and the like.

### REFERENCE SIGNS LIST

1 hollow fiber membrane, 2 porous membrane, 4 first holding member, 5 second holding member, 6 supporting member, 7 treatment-target-water inlet, 8 filtered-water outlet, 10 waste-water outlet, 11 barrel member, 13 cap member, 15 bottom member, 20 membrane member, 30 casing, 40 hollow fiber membrane stack, 50 filtration module, A treatment-target water, B filtered water, C waste water.

1. A hollow fiber membrane comprising polytetrafluoroethylene or modified polytetrafluoroethylene as a main component, wherein the hollow fiber membrane has:
an average outer diameter of 2.10 mm or less and an average thickness of 0.60 mm or less;
an isopropanol bubble point of 90 kPa or more;
a degree of orientation in a longitudinal direction measured by wide-angle X-ray scattering from 72% to 85%; and
an amount of heat of fusion at an endothermic peak in the vicinity of 328° C. from 10.0 J/g to 13.4 J/g.

2. A hollow fiber membrane stack comprising:
the hollow fiber membrane according to claim 1; and
one or a plurality of porous membranes having polytetrafluoroethylene or modified polytetrafluoroethylene as a main component and stacked on an outer circumferential surface of the hollow fiber membrane.

3. A filtration module comprising a plurality of the hollow fiber membrane stacks according to claim 2.
